(19) United States
(12) Patent Application Publication
(10) Pub. No.: US 2026/0264422 A1
(43) Pub. Date: Sep. 10, 2026

(54) SHEET CONVEYING DEVICE, IMAGE FORMING APPARATUS, CONVEYANCE DISTANCE MEASUREMENT METHOD, AND STORAGE MEDIUM

(71) Applicant: Noboru Hirano, Kanagawa (JP)

(72) Inventor: Noboru Hirano, Kanagawa (JP)

(73) Assignee: Ricoh Company, Ltd., Tokyo (JP)

(21) Appl. No.: 19/555,312

(22) Filed: Mar. 3, 2026

(30) Foreign Application Priority Data
Mar. 6, 2025 (JP) 2025-035674

(51) Int. Cl. B41J 11/00; B41J 13/02

(52) U.S. Cl. CPC B41J 11/0095; B41J 11/0045; B41J 13/02; B41J 2203/01

(57) ABSTRACT

A sheet conveying device includes a conveyor, a measuring device, a first sensor, a second sensor, and circuitry. The conveyor conveys a sheet. The measuring device is on the conveyor to measure a conveyance amount of the sheet. The first sensor is downstream from the conveyor in a sheet conveyance direction of the conveyor to detect the sheet. The second sensor is upstream from the conveyor in the sheet conveyance direction of the conveyor to detect the sheet. The circuitry calculates a conveyance distance of the sheet on basis of a measurement result of the conveyance amount of the sheet measured by the measuring device, a first detection result of the sheet detected by the first sensor, a second detection result of the sheet detected by the second sensor, and information indicating physical characteristics of the sheet.

### CROSS-REFERENCE TO RELATED APPLICATIONS

This patent application is based on and claims priority pursuant to 35 U.S.C. § 119(a) to Japanese Patent Application No. 2025-035674, filed on Mar. 6, 2025, in the Japan Patent Office, the entire disclosure of which is hereby incorporated by reference herein.

### BACKGROUND

### Technical Field

The present disclosure relates to a sheet conveying device, an image forming apparatus, a method for measuring a conveyance distance of a sheet, and a storage medium for causing a computer to execute processing for measuring the conveyance distance.

### Related Art

An image forming apparatus that can print on both sides of a sheet performs both-side printing by discharging droplets (ink) onto a first face of the sheet and fixing the droplets, then reversing the sheet to discharge the ink onto a second face on the back side of the sheet and fixing the ink. During printing on the first face and the second face, heat and pressure are applied at the time of fixing the ink onto the sheet, whereby the sheet expands and contracts, and an image magnification error occurs.

Therefore, it is necessary to correct the image magnification error, but the size of the sheet is necessary to correct the image magnification error.

As a device for measuring the size of the sheet, a device for calculating a length (sheet length) of the sheet in a conveyance direction based on a detection result of a rotary encoder attached to a driven roller of a pair of rollers for conveying the sheet and a sensor for detecting leading and trailing ends of the sheet has been proposed.

### SUMMARY

The present disclosure described herein provides a sheet conveying device that includes a conveyor, a measuring device, a first sensor, a second sensor, and circuitry. The conveyor conveys a sheet. The measuring device is on the conveyor to measure a conveyance amount of the sheet. The first sensor is downstream from the conveyor in a sheet conveyance direction of the conveyor to detect the sheet. The second sensor is upstream from the conveyor in the sheet conveyance direction of the conveyor to detect the sheet. The circuitry calculates a conveyance distance of the sheet on basis of a measurement result of the conveyance amount of the sheet measured by the measuring device, a first detection result of the sheet detected by the first sensor, a second detection result of the sheet detected by the second sensor, and information indicating physical characteristics of the sheet.

The present disclosure described herein also provides an image forming apparatus that includes an image forming device and a sheet conveying device. The image forming device forms an image on a sheet. The sheet conveying device conveys the sheet to the image forming device. The sheet conveying device includes a conveyor, a measuring device, a first sensor, a second sensor, and circuitry. The conveyor conveys the sheet. The measuring device is on the conveyor to measure a conveyance amount of the sheet. The first sensor is downstream from the conveyor in a sheet conveyance direction of the conveyor to detect the sheet. The second sensor is upstream from the conveyor in the sheet conveyance direction of the conveyor to detect the sheet. The circuitry calculates a conveyance distance of the sheet on basis of a measurement result of the conveyance amount of the sheet measured by the measuring device, a first detection result of the sheet detected by the first sensor, a second detection result of the sheet detected by the second sensor, and information indicating physical characteristics of the sheet.

The present disclosure described herein further provides a method for measuring a conveyance distance of a sheet by a sheet conveying device that includes a conveyor to convey the sheet, a measuring device on the conveyor, a first sensor downstream from the conveyor in a sheet conveyance direction of the conveyor; and a second sensor upstream from the conveyor in the sheet conveyance direction. The method includes: detecting a leading end of the sheet in the sheet conveyance direction by the first sensor; detecting a trailing end of the sheet in the sheet conveyance direction by the second sensor; measuring a conveyance amount of the sheet by the measuring device; and calculating a conveyance distance of the sheet on basis of a measurement result of the sheet measured by the measuring, a first detection result of the sheet by the detecting of the leading end, a second detection result of the sheet by the detecting of the trailing end, and information indicating physical characteristics of the sheet.

The present disclosure described herein further provides a non-transitory storage medium storing instruction code which, when executed by one or more processors, causes the one or more processors to execute a process of measuring a conveyance distance of a sheet in a sheet conveying device that includes a conveyor to convey the sheet, a measuring device attached on the conveyor, a first sensor downstream from the conveyor in a sheet conveyance direction of the conveyor, and a second sensor upstream from the conveyor in the sheet conveyance direction. The process includes acquiring and calculating. The acquiring acquires, from the sheet conveying device, a measurement result of a conveyance distance of the sheet measured by the measuring device, a first detection result of the sheet detected by the first sensor, and a second detection result of the sheet detected by the second sensor. The calculating calculates a conveyance distance of the sheet on basis of the measurement result, the first detection result, and the second detection result acquired by the acquiring, and information indicating physical characteristics of the sheet.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration example of an image forming apparatus that can perform both-side printing;

FIG. 2 is a diagram illustrating a configuration example of an image forming unit included in an image forming apparatus;

FIGS. 3A and 3B are diagrams illustrating configuration examples of a sheet conveying device;

FIG. 4 is a diagram illustrating an example of output signals of sensors;

FIGS. 5A and 5B are diagrams illustrating problems in a case where a sheet is conveyed by a roller having an elastic body layer and a sheet conveyance distance is calculated;

FIGS. 6A, 6B, and 6C are diagrams illustrating a difference between the related art and an embodiment;

FIGS. 7A and 7B are diagrams illustrating a method for estimating a diameter correction factor;

FIG. 8 is a block diagram illustrating an example of a functional configuration of a sheet conveying device;

FIGS. 9A and 9B are diagrams illustrating examples of a hardware configuration of a sheet conveying device;

FIG. 10 is a flowchart illustrating an example of processing executed by a sheet conveying device; and

FIG. 11 is a flowchart illustrating an example of conveyance distance arithmetic processing of a sheet.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

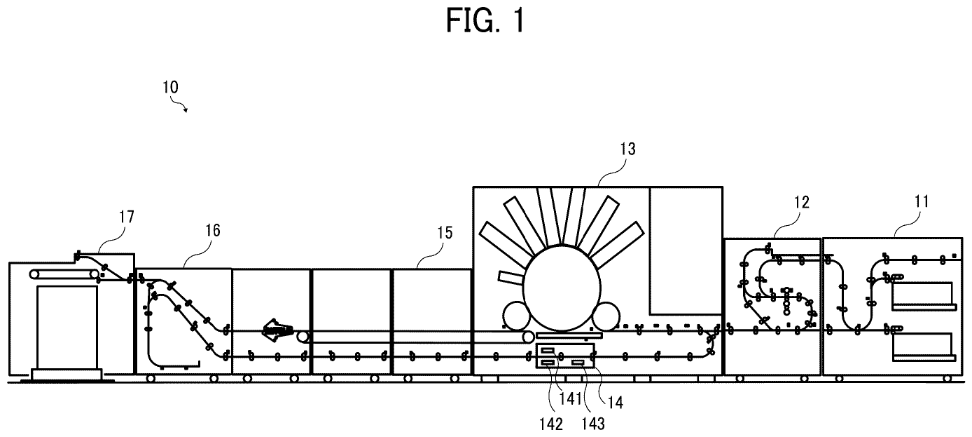

Although some embodiments of the present disclosure are described below, embodiments of the present disclosure is not limited to the later-described embodiments. FIG. 1 is a diagram illustrating a configuration example of an image forming apparatus that can perform both-side printing. The image forming apparatus that can perform both-side printing is, for example, a linehead type duplex printing machine, and here, the image forming apparatus will be described as a linehead type duplex printing machine. The linehead is a type of head that performs recording by conveying a sheet as a recording medium under a secured head. The head is a mechanism that has fine nozzles, discharges droplets (ink) from the nozzles toward a sheet, and reproduces print data as an image or the like on the sheet.

The sheet needs only be thin and rectangular and may be of any type, including paper sheet such as cut paper sheet and postcards, cloth sheet, and a film sheet such as over head projector (OHP) film. The following description is given with a paper sheet as an example of the sheet.

An image forming apparatus 10 includes a sheet feeding unit 11, a pre-coating unit 12, and an image forming unit 13. The sheet feeding unit 11 stores a plurality of paper sheets, and separates and feeds the paper sheets one by one. The pre-coating unit 12 applies a pre-coating liquid for facilitating fixing of the ink according to the paper sheet. The image forming unit 13 includes an image forming drum and lineheads, winds a paper sheet around the image forming drum, and performs printing by the lineheads. Before the paper sheet is wound around the image forming drum, the image forming unit 13 detects a shift (main scanning shift) of the paper sheet in a main-scanning direction that is a direction perpendicular to a conveyance direction of the paper sheet, and corrects the main scanning shift.

The image forming apparatus 10 includes an image position detecting unit 14, a drying-and-cooling unit 15, a reversing unit 16, and a sheet ejecting unit 17. The image position detecting unit 14 detects a position of an image printed on a paper sheet. Then, the image position detecting unit 14 corrects the image on the basis of the detected image position. Specifically, the image position detecting unit 14 corrects the image position of the image formed on the back face that is a second face of the paper sheet on the basis of the image position of the image formed on the front face that is a first face of the paper sheet, and performs front and back registration. The image formed on the front face is a test-printed image and is used to correct the image position of the image on the back face for production printing. The image position detecting unit 14 calculates a sheet conveyance distance in order to calculate a length (sheet length) of the paper sheet in the conveyance direction. The image position detecting unit 14, which is an example of the image position detector, includes hardware such as a central processing unit (CPU) 141, a read-only memory (ROM) 142, and a random-access memory (RAM) 143 that executes arithmetic processing and the CPU 141 can read a program stored in the ROM 142 into the RAM 143 and execute the program, thereby implementing processing such as correction of the image position and calculation of the sheet conveyance distance.

The drying-and-cooling unit 15 removes moisture of the ink on the paper sheet and fixes the image formed by ink discharge onto the paper sheet. The drying-and-cooling unit 15 cools the paper sheet having a high temperature as necessary. The reversing unit 16 performs switchback reversal at the time of back face automatic printing, and conveys the paper sheet toward the side where the image forming unit 13 is disposed. The sheet ejecting unit 17 sequentially ejects paper sheets that have been printed.

In the image forming apparatus 10, the sheet feeding unit 11, the pre-coating unit 12, the image forming unit 13, the drying-and-cooling unit 15, the reversing unit 16, and the sheet ejecting unit 17 are arranged side by side from the right side to the left side, and the paper sheet is conveyed from the right side to the left side to be printed. Note that the image position detecting unit 14 is disposed in the image forming unit 13.

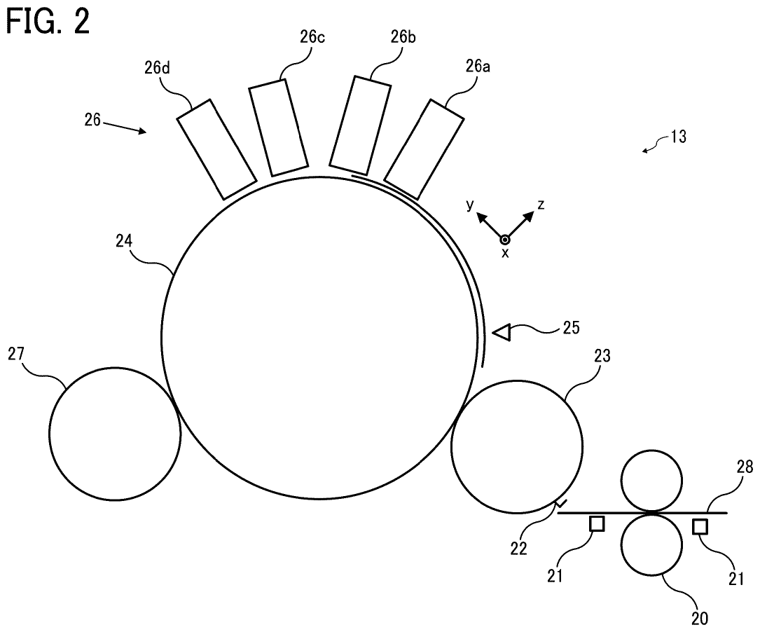

FIG. 2 is a diagram illustrating a configuration example of the image forming unit as an example of an image forming device included in the image forming apparatus. The image forming unit 13 includes a shift roller 20, edge sensors 21, a gripper 22, an inlet cylinder 23, an image forming drum 24 as a drum, a print timing sensor 25, a printhead (linehead) 26, and an outlet cylinder 27.

The edge sensors 21 are disposed on a front flow side and a back flow side of the shift roller 20 in the conveyance direction of a paper sheet 28, and detect the amount of positional shift in the main-scanning direction and the amount of skew (tilt). The main-scanning direction is a direction (x direction) perpendicular to the conveyance direction of the paper sheet 28. The shift roller 20 corrects the amount of positional shift in the main-scanning direction and the skew based on the amount of positional shift in the main-scanning direction and the amount of skew detected by the edge sensors 21.

The paper sheet 28 corrected by the shift roller 20 is conveyed to the inlet cylinder 23, and a leading end of the paper sheet 28 is gripped by the mechanically opening and closing gripper 22 attached to the inlet cylinder 23. The inlet cylinder 23, the image forming drum 24, and the outlet cylinder 27 are coupled by gears, and the paper sheet 28 is conveyed from the inlet cylinder 23 to the outlet cylinder 27 via the image forming drum 24 while being gripped by the grippers attached to the inlet cylinder 23, the image forming drum 24, and the outlet cylinder 27, respectively.

Inkjet (IJ) heads 26a, 26b, 26c, and 26d that discharge inks of each color are disposed above the paper sheet 28 that is conveyed so as to be wound around the front face of the image forming drum 24 located between the inlet cylinder 23 and the outlet cylinder 27. Each color is, for example, black, yellow, magenta, or cyan. The IJ heads 26a, 26b, 26c, and 26d of each color are aligned in the main-scanning direction to constitute the linehead 26, and when the paper sheet 28 passes under the linehead 26, ink is discharged from the IJ heads 26a, 26b, 26c, and 26d to form an image on the paper sheet 28. The timing at which the IJ heads 26a, 26b, 26c, and 26d discharge the ink is determined based on the timing at which the paper sheet 28 passes under the print timing sensor 25 disposed on the front flow side of the IJ heads 26a, 26b, 26c, and 26d.

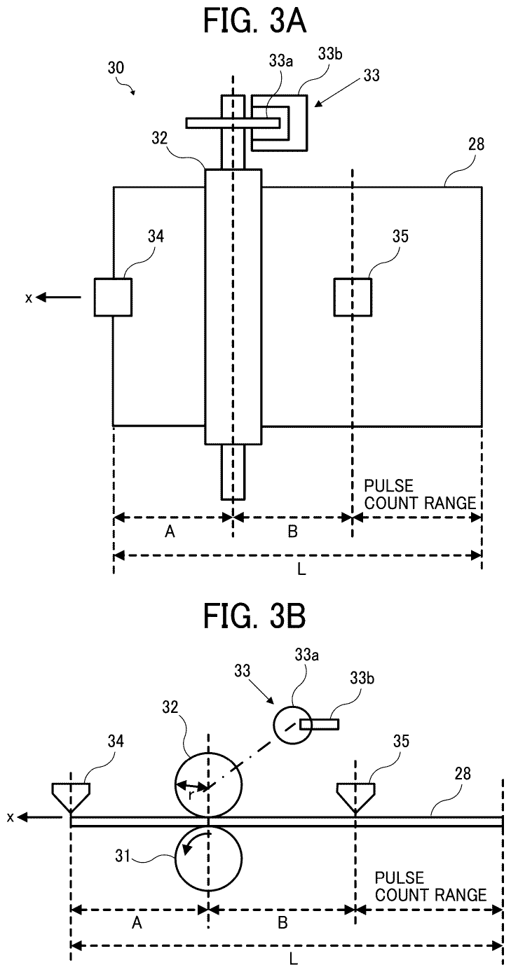

FIGS. 3A and 3B are diagrams illustrating configuration examples of a sheet conveying device. FIG. 3A is a plan view of a sheet conveying device 30 when the sheet conveying device 30 is viewed from the upper side in a vertical direction, and FIG. 3B is a side view of the sheet conveying device 30 when the sheet conveying device 30 is viewed from the side. On a conveyance path that conveys the paper sheet 28, a driving roller 31 that is rotationally driven by a driving unit such as a motor and a driving force transmission unit such as a gear or a belt, and a driven roller 32 that rotates with the rotation of the driving roller 31 while nipping the paper sheet 28 together with the driving roller 31 are disposed. The driving roller 31 and the driven roller 32 are an example of a sheet conveyor that conveys the paper sheet 28.

The driving roller 31 has an elastic body layer on a front face thereof in order to generate a sufficient frictional force with the paper sheet 28, and nips and conveys the paper sheet 28 with the driven roller 32. The elastic body layer is, for example, a rubber layer. The driven roller 32 is arranged so as to be pressed against and come into contact with the driving roller 31 by a biasing unit such as a spring, and rotates passively due to the frictional force generated with the paper sheet 28 when the driving roller 31 rotates to convey the paper sheet 28.

A rotary encoder 33 is mounted on a rotation shaft of the driven roller 32 as an example of a rotation detector. The rotary encoder 33 includes an encoder disk 33a that rotates with the rotation of the rotation shaft, and an encoder sensor 33b that generates a pulse signal in response to the rotation of the encoder disk 33a. As an example of a conveyance amount measurer, a pulse counting unit counts a pulse signal generated by the encoder sensor 33b and measures a rotation amount of the driven roller 32 as a conveyance amount of the paper sheet 28. The rotary encoder 33 and the pulse counting unit function as a measuring device that measures the conveyance amount of the paper sheet 28.

Note that the rotary encoder 33 is not limited to being mounted on the rotation shaft of the driven roller 32, and may be mounted on the rotation shaft of the driving roller 31. The smaller the diameter of the roller (the driven roller 32 or the driving roller 31) to which the rotary encoder 33 is mounted, the greater the number of rotations during conveyance of the paper sheet 28 and the more pulses are counted, which enables high-accuracy counting of the conveyance distance of the paper sheet 28, and is therefore preferable.

In addition, it is desirable that the roller to which the rotary encoder 33 is mounted is formed of a metal roller in order to ensure shaft runout accuracy. The shaft runout is a shift generated between the center of the shaft and the center of the trajectory in which the shaft rotates. In this manner, it is possible to measure the conveyance distance of the paper sheet 28 with high accuracy by ensuring the shaft runout accuracy and suppressing the runout of the rotation shaft.

In the conveyance path of the paper sheet 28, sensors 34 and 35 are disposed upstream and downstream from the driving roller 31 and the driven roller 32. Note that the sheet feeding unit 11 side of the driving roller 31 and the driven roller 32 is upstream in the conveyance direction of the paper sheet 28, and the sheet ejecting unit 17 side opposite thereto is downstream in the conveyance direction of the paper sheet 28. The sensors 34 and 35 detect passage of an end of the paper sheet 28 to be conveyed. The sensors 34 and 35 can be transmissive or reflective optical sensors that can detect the end of the paper sheet 28 with high accuracy. The optical sensor includes a light emitting element that emits light and a light receiving element that receives light. In the transmissive type, the light receiving element detects a change in the amount of light when light emitted from the light emitting element passes through a detection target, converts the change into an electric signal, and outputs the electric signal. In the reflective type, the light receiving element detects a change in the amount of light when the light emitted from the light emitting element is reflected to the detection target, converts the change into an electric signal, and outputs the electric signal.

The start trigger sensor 34 disposed downstream from the driving roller 31 and the driven roller 32 in the conveyance direction of the driving roller 31 and the driven roller 32 is a start trigger sensor that serves as a downstream sensor for detecting the passage of a leading end of the paper sheet 28. The leading end of the paper sheet 28 is an end that reaches the sensors 34 and 35 first among the ends of the paper sheet 28 conveyed on the conveyance path. On the other hand, the end that reaches the sensors 34 and 35 last is a trailing end of the paper sheet 28.

The stop trigger sensor 35 disposed upstream from the driving roller 31 and the driven roller 32 in the conveyance direction of the driving roller 31 and the driven roller 32 is a stop trigger sensor that serves as an upstream sensor for detecting the passage of the trailing end of the paper sheet 28. Hereinafter, the sensors 34 and 35 will be referred to as a start trigger sensor 34 and a stop trigger sensor 35, respectively.

The start trigger sensor 34 and the stop trigger sensor 35 are disposed such that the positions in a width direction perpendicular to the conveyance direction of the paper sheet 28 are substantially the same. As a result, it is possible to minimize the influence of a conveyance posture (skew with respect to the conveyance direction) of the paper sheet 28 and to more accurately measure the conveyance distance of the paper sheet 28.

A distance A illustrated in FIGS. 3A and 3B indicates a distance between the start trigger sensor 34 and the driving roller 31 and the driven roller 32, and a distance B indicates a distance between the driving roller 31 and the driven roller 32 and the stop trigger sensor 35. Note that, more precisely, these distances indicate a distance between the center positions in the conveyance direction. In the case of the distance A, it is a distance between the center position of the shaft of the driving roller 31 and the center position of the start trigger sensor 34 in the conveyance direction.

For example, the driving roller 31 rotates counterclockwise as indicated by an arrow in FIG. 3B, and the driven roller 32 comes into contact with the driving roller 31 and rotates clockwise following the driving roller 31 when the paper sheet 28 is not conveyed (idling). When conveying the paper sheet 28, the driven roller 32 comes into contact with the paper sheet 28 and rotates clockwise following the paper sheet 28 conveyed in the conveyance direction by the driving roller 31. When the driven roller 32 rotates, a pulse signal is generated by the rotary encoder 33 mounted on the rotation shaft of the driven roller 32.

When the start trigger sensor 34 detects that the paper sheet 28 has been conveyed in the direction indicated by an arrow x and the leading end of the paper sheet 28 has passed, the pulse counting unit starts counting the number of pulses of the pulse signal generated by the rotary encoder 33. Then, when the stop trigger sensor 35 detects that the trailing end of the paper sheet 28 has passed, the pulse counting unit ends the counting of the number of pulses of the pulse signal generated by the rotary encoder 33.

A length (sheet length) L of the paper sheet 28 in the conveyance direction can be obtained by adding the distance A, the distance B, and the sheet conveyance distance (pulse count range) calculated from a pulse count result of the pulse counting unit.

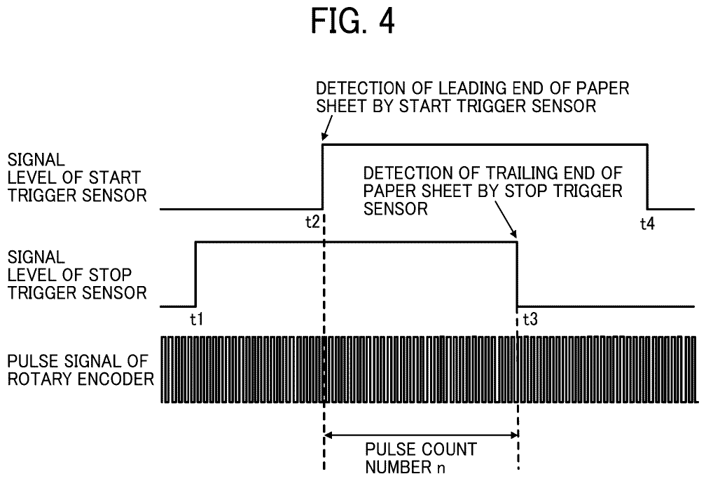

FIG. 4 is a diagram illustrating an example of an output signal of each sensor. The output signals of each sensor are an output signal of the start trigger sensor 34, an output signal of the stop trigger sensor 35, and a pulse signal generated by the rotary encoder 33.

When the driven roller 32 rotates, the pulse signal is generated by the rotary encoder 33 mounted on the rotation shaft of the driven roller 32. The stop trigger sensor 35 detects that the paper sheet 28 has been conveyed and the leading end of the paper sheet 28 has passed at time t1, and then the start trigger sensor 34 detects that the leading end of the paper sheet 28 has passed at time t2. Subsequently, the stop trigger sensor 35 detects that the trailing end of the paper sheet 28 has passed at time t3, and the start trigger sensor 34 detects that the trailing end of the paper sheet 28 has passed at time t4. At this time, the pulse counting unit counts the number of pulses of the pulse signal generated by the rotary encoder 33 from when the start trigger sensor 34 detects that the leading end of the paper sheet 28 has passed at time t2 to when the stop trigger sensor 35 detects that the trailing end of the paper sheet 28 has passed at time t3.

When the radius of the driven roller 32 on which the rotary encoder 33 is mounted is r [mm], the number of encoder pulses for one rotation of the driven roller 32 is N, and the number of pulses counted within the pulse count time is n [/r], a conveyance distance L [mm] of the paper sheet 28 conveyed from the time t2 to the time t3 can be calculated by the following Formula 1.

$$L = ( \frac{n}{N} ) \times 2 π r \qquad ( Formula 1 )$$

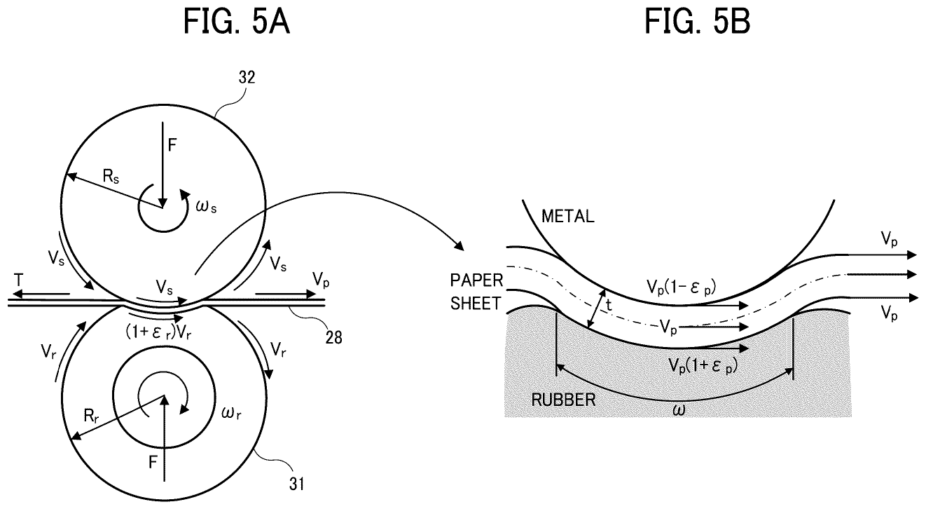

FIGS. 5A and 5B are diagrams illustrating problems in a case where the sheet is conveyed by the roller having the elastic body layer and the sheet conveyance distance is calculated. FIG. 5A illustrates the paper sheet 28 being nipped and conveyed by the driving roller 31 and the driven roller 32 included in the sheet conveying device 30. FIG. 5B is an enlarged view illustrating the paper sheet 28 nipped between the driving roller 31 and the driven roller 32. FIGS. 5A and 5B are diagrams cited from Hiroshi Yamaura, “Analysis of Flexible-media Transport Characteristics of Rubber-layered Roller and Its Application to Design”, Journal of the Japan Society of Precision Engineering, Vol. 78, No. 5, 2012, pp. 363 to 367.

The driving roller 31 has the elastic body layer on a front face thereof in order to generate a sufficient frictional force with the paper sheet 28. The driven roller 32 is a metal roller in which the rotary encoder 33 is mounted on the rotation shaft in order to ensure shaft runout accuracy. The driven roller 32 is arranged so as to be pressed against and come into contact with the driving roller 31 by the biasing unit such as a spring. When the driving roller 31 rotates to convey the paper sheet 28, the driven roller 32 rotates passively due to the frictional force generated with the paper sheet 28.

When the driven roller 32 presses against the driving roller 31 via the paper sheet 28, the elastic body layer on the front face of the driving roller 31 is pressed and deformed by the applied pressure, causing the paper sheet 28 to be wound around the driven roller 32. In consideration of the thickness of the paper sheet 28, even if the conveyance path extends linearly, a conveyance speed Vₚ of the paper sheet 28 becomes larger than a rotation speed Vₛ of the front face of the driven roller 32, and the conveyance distance of the paper sheet 28 per encoder pulse count is not expressed only by the diameter of the driven roller 32.

Assuming that the radius of the driven roller 32 is Rₛ, the angular velocity is ωₛ, and the thickness of the paper sheet 28 when nipped is t, the relationship between the rotation speed Vₛ of the front face of the driven roller 32 and the conveyance speed Vₚ of the paper sheet 28 can be expressed by the following Formulas 2 and 3. In Formula 3, the distance from the center of the driven roller 32 to the center of the thickness of the conveyed paper sheet 28 is defined as the apparent diameter of the driven roller. Note that the thickness of the paper sheet 28 nipped between the driving roller 31 and the driven roller 32 varies depending on the applied pressure, the rigidity of the paper sheet 28, and the like, and thus is not limited to the original thickness of the paper sheet 28.

$${V}_{s} = {R}_{s} \times {ω}_{s} \qquad ( Formula 2 )$$

$${V}_{p} = ( {R}_{s} + \frac{t}{2} ) \times {ω}_{s} \qquad ( Formula 3 )$$

In addition, when the number of encoder pulses for one rotation of the driven roller 32 is N, a moving distance Lₛ of the front face of the driven roller 32 and a conveyance distance Lₚ of the paper sheet 28 per encoder pulse count can be expressed by the following Formulas 4 and 5.

$${L}_{s} = \frac{2 π {R}_{s}}{N} \qquad ( Formula 4 )$$

$${L}_{p} = \frac{2 π ( {R}_{s} + \frac{t}{2} )}{N} \qquad ( Formula 5 )$$

As in the above Formula 4, conventionally, the conveyance distance of the paper sheet 28 has been calculated only based on the diameter of the driven roller 32, but when the thickness t of the paper sheet 28 is considered as in Formula 5 above, the conveyance distance of the paper sheet 28 becomes longer by 2π(t/2)/N per encoder pulse count. Therefore, in the conventional method for calculating the conveyance distance of the paper sheet 28 only based on the diameter of the driven roller 32, the conveyance distance is calculated to be short by 2π(t/2)/N per encoder pulse count.

Furthermore, the influence of the thickness of the paper sheet 28 when nipped by the driving roller 31 and the driven roller 32 can be expressed as the following Formula 6 using the correction factor (diameter correction factor) a (%) of the diameter of the driven roller 32. The diameter correction factor is used as a diameter correction value for correcting the diameter of the driven roller 32 when nipping the paper sheet 28.

$${L}_{p} = \frac{2 π {R}_{s} \times ( 1 + a )}{N} \qquad ( Formula 6 )$$

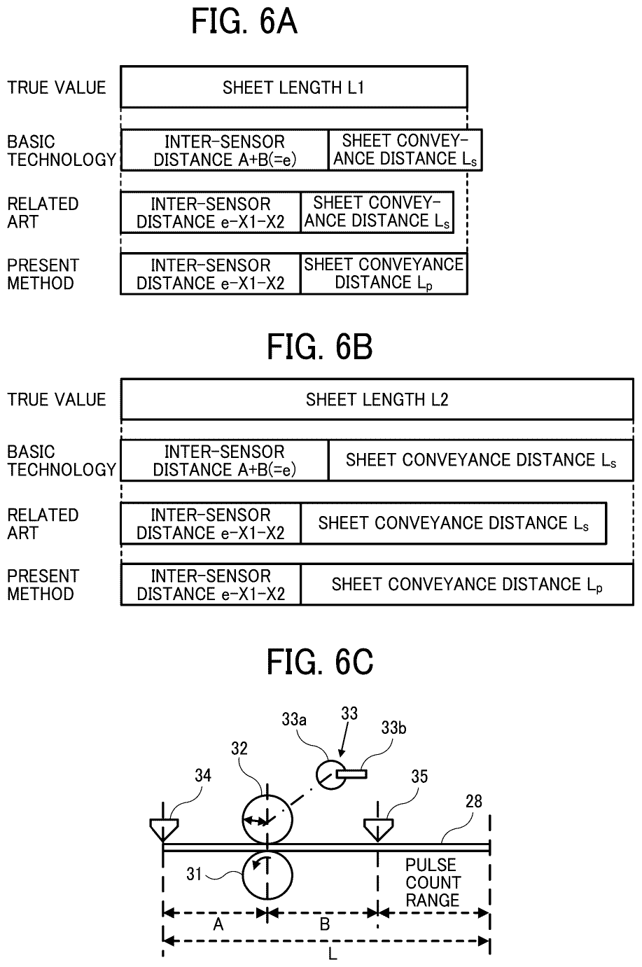

FIGS. 6A, 6B, and 6C are diagrams illustrating a difference between the related art and the present method. The true sheet length (true value) is a length obtained by measuring the length of a paper sheet 28 in the conveyance direction using an external measuring instrument such as a scale, and is L1 and L2. The basic technology represents a case without correction, and calculates a length obtained by adding a sheet conveyance distance Lₛ calculated only by the diameter of the driven roller 32 to an inter-sensor distance A+B (=e).

The related art is the technology described in Japanese Unexamined Patent Application Publication No. 2013-40039, and represents a case of correcting a detection shift in the leading and trailing end detection sensors that determine the conveyance distance timing of the paper sheet 28. Assuming that the detection shifts of the leading and trailing ends are X1 and X2, the inter-sensor distance is corrected to e−X1-X2, the related art is calculated as a length obtained by adding the sheet conveyance distance Lₛ calculated only by the diameter of the driven roller 32. Therefore, when the sheet length is short, the measurement error becomes relatively small with respect to the true value.

In the related art, the correction amount is common (fixed value) even when the sheet length is different as long as the sheet type is the same. Therefore, when the sheet length becomes long, the measurement error with respect to the true value becomes large, and the measurement deviation of the sheet length due to the characteristics of the paper sheet 28 is not eliminated.

On the other hand, in the present method, as described above, the conveyance distance of the paper sheet 28 per encoder pulse count is corrected in consideration of physical characteristics such as the thickness of the paper sheet 28. Therefore, the correction amount increases in proportion to the conveyance distance of the paper sheet 28, and the correction amount of the conveyance distance increases even if the sheet length increases, so that the measurement error does not increase, and the measurement deviation of the sheet length due to the characteristics of the paper sheet 28 can be eliminated. For example, as the physical characteristics, the thickness of the sheet, the bending rigidity in the conveyance direction, the friction coefficient, the sheet material, and the like can be used. The physical characteristics of the sheet are not limited to the above.

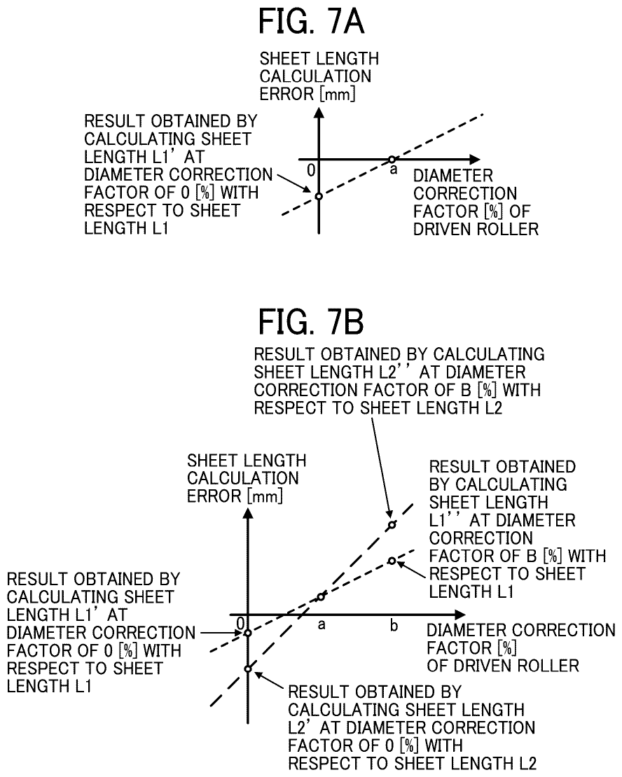

FIGS. 7A and 7B are diagrams illustrating a method for estimating the diameter correction factor. FIGS. 7A and 7B illustrate examples of two methods for estimating the conveyance distance Lₚ of the paper sheet 28 per encoder pulse count when the paper sheet 28 is nipped, that is, the diameter correction factor a (%) of the driven roller 32.

FIG. 7A is an example of a method for calculating the diameter correction factor using a single paper sheet with a known sheet length, and the true sheet length L1 is measured in advance using the external measuring instrument. The paper sheet 28 is conveyed in the configurations illustrated in FIGS. 3A and 3B, and a sheet length L1′ at the diameter correction factor of 0 [%] is calculated according to the output of each sensor using the above Formula 1. Assuming that an encoder pulse count number is n1, the radius of the driven roller 32 is r, the number of encoder pulses for one rotation of the driven roller 32 is N, the distance between the start trigger sensor 34 and the driving roller 31 and the driven roller 32 is A, and the distance between the stop trigger sensor 35 and the driving roller 31 and the driven roller 32 is B, L1′ can be calculated by the following Formula 7.

$${L 1}^{′} = n 1 \times ( \frac{2 π r}{N} ) + A + B \qquad ( Formula 7 )$$

A sheet length calculation error is a difference between the true sheet length L1 and the sheet length L1′ calculated by Formula 7 above. The diameter correction factor a [%] can be calculated from the apparent driven roller diameter r′ when the sheet length calculation error is 0. That is, the driven roller diameter r′ that results in the true sheet length L1 when the encoder pulse count number is n1 need only be calculated, and can be expressed as the following Formula 8. Formula 9 can be derived by modifying Formula 8. The diameter correction factor a can be calculated using the following Formula 9.

$$L 1 = n 1 \times ( \frac{2 π {r}^{′}}{N} ) + A + B = n 1 \times ( \frac{2 π r ( 1 + a )}{N} ) + A + B \qquad ( Formula 8 )$$

$$a = - 1 + \frac{( L 1 - A - B )}{2 π rn 1} \times N \qquad ( Formula 9 )$$

However, the method for calculating the diameter correction factor a using the above Formula 9 is a calculation method assuming that there are no errors in the distance A and the distance B. In a case where there are actually errors in the distance A and the distance B, there is a concern that the calculation result will deviate. Therefore, a method for calculating the diameter correction factor a without using the distance A and the distance B will be described with reference to FIG. 7B. FIG. 7B is a method for calculating the diameter correction factor using two paper sheets with different known sheet lengths. Note that the lengths of the two paper sheets are measured in advance using the external measuring instrument. Here, the lengths of the two paper sheets are L1 and L2, and L1<L2.

In the configurations illustrated in FIGS. 3A and 3B, two paper sheets 28 are conveyed, and the sheet lengths L1 and L2 are calculated according to the output of each sensor using the above Formula 1. Assuming that the encoder pulse count numbers are n1 and n2, the radius of the driven roller 32 is r, the number of encoder pulses for one rotation of the driven roller 32 is N, the distance between the start trigger sensor 34 and the driving roller 31 and the driven roller 32 is A, the distance between the stop trigger sensor 35 and the driving roller 31 and the driven roller 32 is B, and, for each paper sheet 28, the sheet length calculation error is y and the diameter correction factor is x, the calculation error with the sheet length L1 can be expressed by the following Formula 10, and the calculation error with the sheet length L2 can be expressed by the following Formula 11.

$$y = n 1 \times ( \frac{2 π r ( 1 + x )}{N} ) + A + B - L 1 \qquad ( Formula 10 )$$

$$y = n 2 \times ( \frac{2 π r ( 1 + x )}{N} ) + A + B - L 2 \qquad ( Formula 11 )$$

Since it is sufficient to calculate the diameter correction factor a when the calculation error calculated by the above Formula 10 is equal to the calculation error calculated by the above Formula 11, the following Formula 12 holds, and the following Formula 12 can be deformed to derive the following Formula 13.

$$n 1 \times ( \frac{2 π r ( 1 + x )}{N} ) + A + B - L 1 = n 2 \times ( \frac{2 π r ( 1 + x )}{N} ) + A + B - L 2 \qquad ( Formula 12 )$$

$$x = ( \frac{( L 1 - L 2 ) \times N \times ( n 1 - n 2 )}{2 π r} ) - 1 \qquad ( Formula 13 )$$

Here, if L1 and L2 are measured in advance by the external measuring instrument using the same measurement method, the measurement error can be offset by L1-L2, and the diameter correction factor a can be calculated with higher accuracy than the method for calculating from one paper sheet 28. The number of paper sheets is not limited to two. A highly reliable diameter correction factor a can be calculated by using three or more paper sheets 28 with different lengths, calculating the respective calculation errors, and obtaining the diameter correction factor a when the respective calculation errors are equal.

Here, the sheet length is measured in advance, and the diameter correction factor a is calculated using the sheet length. However, the present disclosure is not limited thereto, and a method may be adopted in which coefficients are determined for each factor affecting winding such as the thickness of the paper sheet 28, the friction coefficient, and the bending rigidity in the conveyance direction, and the diameter correction factor a is calculated using those coefficients.

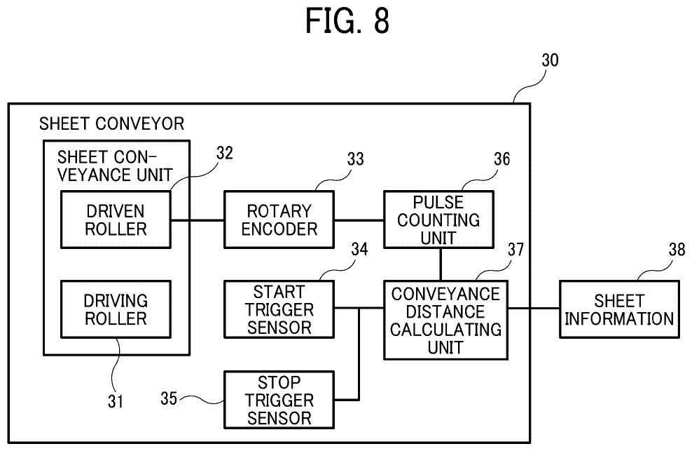

FIG. 8 is a block diagram illustrating an example of a functional configuration of the sheet conveying device according to the present embodiment. The sheet conveying device 30 includes the driving roller 31 and the driven roller 32 as the sheet conveyor. The sheet conveying device 30 includes the rotary encoder 33, the start trigger sensor 34, and the stop trigger sensor 35 as various sensors.

The rotary encoder 33 includes the encoder disk 33a and the encoder sensor 33b mounted on the driven roller 32, and generates the pulse signal. As a first sensor, the start trigger sensor 34 is disposed on the back flow side of the driving roller 31 and the driven roller 32 in the conveyance direction of the paper sheet 28, and detects the paper sheet 28. As a second sensor, the stop trigger sensor 35 is disposed on the front flow side of the driving roller 31 and the driven roller 32 in the conveyance direction of the paper sheet 28, and detects the paper sheet 28.

The sheet conveying device 30 includes a pulse counting unit 36 and a conveyance distance calculating unit 37 which are implemented by the image position detecting unit 14. The pulse counting unit 36 counts the number of pulses of the pulse signal generated by the encoder sensor 33b by the rotation of the encoder disk 33a of the rotary encoder 33, and measures the rotation amount of the driven roller 32 as the conveyance amount of the paper sheet 28. The conveyance distance calculating unit 37 calculates the conveyance distance of the paper sheet 28 by the sheet conveyor based on the detection results of the paper sheet 28 by the start trigger sensor 34 and the stop trigger sensor 35 and the rotation amount of the driven roller 32 measured by the pulse counting unit 36.

In addition to the detection result and the rotation amount of the driven roller 32, the conveyance distance calculating unit 37 can calculate the conveyance distance of the paper sheet 28 in consideration of the winding of the paper sheet 28 around the driven roller 32 on the basis of sheet information 38 transmitted from a controller or the like that controls the operation of the image forming apparatus 10. The sheet information 38 is, for example, a characteristic value that affects winding, such as a diameter correction factor associated with the type of the selected paper sheet 28, the thickness of the paper sheet 28, the friction coefficient, and the bending rigidity in the conveyance direction.

When the radius of the driven roller 32 provided with the rotary encoder 33 is r [mm], the number of encoder pulses for one rotation of the driven roller 32 is N, the number of pulses counted during the pulse counting time is n [/r], and the diameter correction factor of the driven roller 32 is a [%], the conveyance distance calculating unit 37 can calculate the conveyance distance L of the paper sheet 28 by the following Formula 14.

$$L = ( \frac{n}{N} ) \times 2 π r \times ( 1 + a ) \qquad ( Formula 14 )$$

The diameter correction factor a of the driven roller 32 may be determined according to factors such as the thickness of the paper sheet 28, the friction coefficient, and the bending rigidity in the conveyance direction of the paper sheet 28 associated with the type of the paper sheet 28.

For example, when a diameter correction factor of the driven roller 32 according to the thickness of the paper sheet 28 is b (%), a diameter correction factor of the driven roller 32 according to the friction coefficient is c (%), and a diameter correction factor of the driven roller 32 according to the bending rigidity of the paper sheet 28 in the conveyance direction is d (%), Formula 14 can be rewritten as the following Formula 15.

$$L = ( \frac{n}{N} ) \times 2 π r \times ( 1 + b ) \times ( 1 + c ) \times ( 1 + d ) \qquad ( Formula 15 )$$

As in the above Formula 15, by dividing the coefficients for each physical characteristic of the paper sheet 28, it is possible to perform versatile correction that can cope with the type of unevaluated paper sheet 28.

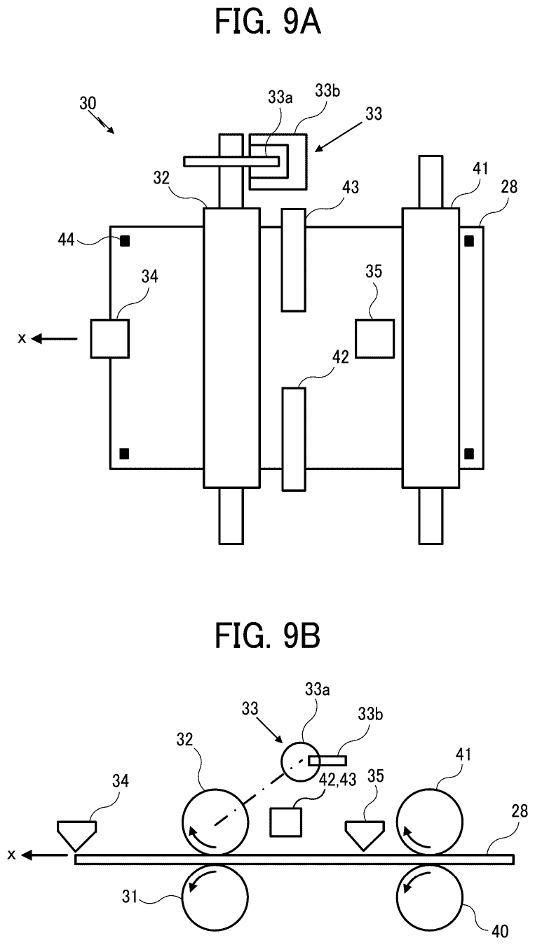

FIGS. 9A and 9B are diagrams illustrating examples of a hardware configuration of the sheet conveying device according to the present embodiment. FIG. 9A is a plan view of the sheet conveying device 30 as viewed from the upper side, and FIG. 9B is a side view of the sheet conveying device 30 as viewed from the side.

Similarly to the conventional configuration illustrated in FIGS. 3A and 3B, the sheet conveying device 30 includes the driving roller 31 and the driven roller 32, the rotary encoder 33 mounted on the driven roller 32, the start trigger sensor 34, and the stop trigger sensor 35. The sheet conveying device 30 is provided with a second driving roller 40 and a second driven roller 41 that nip and convey the paper sheet 28 on the front flow side of the driving roller 31 and the driven roller 32 and on the front flow side of the stop trigger sensor 35.

Immediately after the trailing end of the paper sheet 28 has passed the second driving roller 40 and the second driven roller 41, the trailing end of the paper sheet 28 becomes free to move, and the paper sheet 28 does not lie flat on a conveyor belt until the paper sheet 28 is stabilized. For this reason, it is desirable that the stop trigger sensor 35 be spaced apart from the second driving roller 40 and the second driven roller 41 by a distance that can secure a time for which the paper sheet 28 is adequately stabilized.

The sheet conveying device 30 includes contact image sensors (CIS) 42 and 43 as an image detection unit at positions where ends of the paper sheet 28 on the front side and the back side of the paper sheet 28 in a direction perpendicular to the conveyance direction of the paper sheet 28 can be detected between the driving roller 31 and the driven roller 32, and the stop trigger sensor 35. The CISs 42 and 43 detect edges at four corners of the paper sheet 28 and marks 44 printed at the four corners. The shape and the image position of the paper sheet 28 can be detected by detecting the edges and the marks by the CISs 42 and 43.

In a case where the sheet length is detected by the CISs 42 and 43, a resolution of the CISs 42 and 43 in a sub-scanning direction is determined by a reading cycle of the CISs 42 and 43 and the conveyance speed of the paper sheet 28, and the sheet length can be calculated from the resolution.

However, since the conveyance speed of the paper sheet 28 fluctuates due to the influence of the roller diameter difference and the roller eccentricity of the sheet conveyor, calculating the sheet length at the conveyance speed of the fixed paper sheet 28 results in an error.

Therefore, the sheet length can be corrected by the sheet length calculation result by the rotary encoder 33 described above. This makes it possible to detect a more accurate sheet shape and image position.

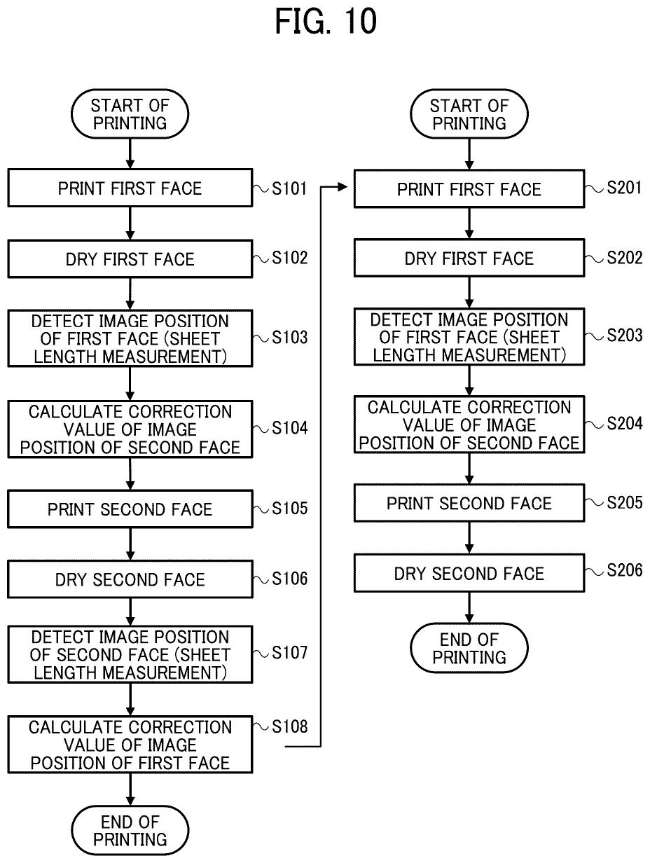

Based on the detected image position, the image is corrected as follows. Specifically, the image position of the back face that is the second face is corrected based on the image position of the front face that is the first face, and the front and back registration is performed in real time. The position of the test printed image is detected, and an absolute image position on the front face is corrected so as to be the expected image position in the production printing. The detailed processing will be described with reference to FIG. 10.

FIG. 10 is a flowchart illustrating an example of processing executed in the sheet conveying device according to the present embodiment. The image forming apparatus 10 includes a test printing mode, and executes processing of calculating a correction value of the absolute image position of the first face in the test printing mode. After the processing is executed in the test printing mode, the production printing is executed.

When the processing in the test printing mode starts, in step S101, the first face is printed without applying correction, and in step S102, the first face is dried. This drying causes the sheet to expand or contract. In step S103, the present method described above is applied, the sheet length calculation result by the rotary encoder 33 is corrected, and the accurate image position of the first face is detected. By detecting the image position of the first face, it is possible to detect an image position affected by image formation deviation and dry shrinkage at the time of non-correction.

In step S104, the image position of the second face is corrected based on the image position of the first face, and a correction value of the image position of the second face is calculated. This correction value is a real-time front and back registration correction value. By using this correction value, the image correction value for the second face can be calculated relative to the first face, and the second face can be printed so that the front and back are registered one by one in real time.

In step S105, the image of the second face is printed relative to the image position of the first face. In step S106, the second face is dried. As a result, the sheet expands and contracts. In step S107, similarly to step S103 described above, the present method described above is applied, the sheet length calculation result by the rotary encoder 33 is corrected, and the accurate image position of the second face is detected. Then, in step S108, a correction value of the image position of the first face is calculated based on the image position of the second face. By detecting the image position of the dried second face of the paper sheet 28 after the printing of the second face, it is possible to detect the image position affected by the dry shrinkage twice. When the correction value of the image position of the first face is calculated, the process in the test printing mode is ended. The result calculated in the test printing mode is used to calculate the correction value of the absolute image position of the first face in the production printing.

When the correction value of the image position of the first face is calculated in step S108, the execution of the production printing is started, and the printing of the first face is executed in step S201. Printing of the first face is executed based on the correction value of the absolute image position of the first face calculated in the test printing mode. In step S202, the first face is dried. Since the image shrinks through two times of drying in addition to the correction of the positional shift, the image is printed large in advance.

In step S203, the present method is applied as in step S103 in the test printing mode to detect the image position of the first face, and in step S204, the image position of the second face is corrected based on the image position of the first face, and a correction value of the image position of the second face is calculated.

In step S205, the image of the second face is printed relative to the image position of the first face. Then, in step S206, the second face is dried. As a result, the sheet expands and contracts, but a printed matter in which the absolute image position of the first face and the front and back registration are correctly aligned is output. When the printed matter printed on both sides is output, the production printing is ended.

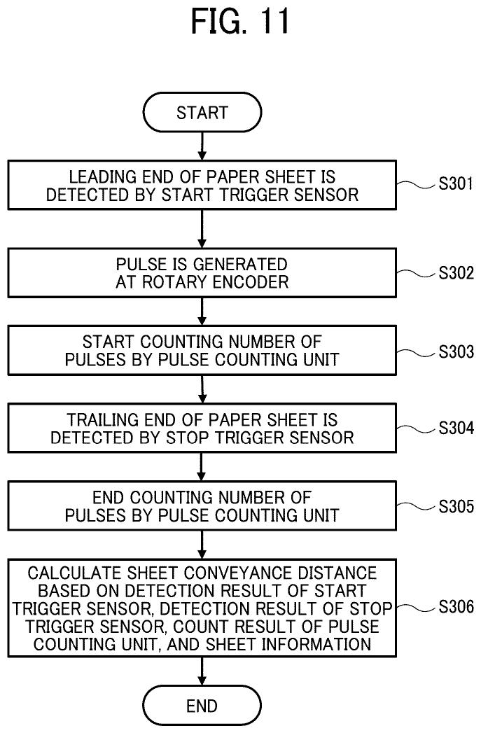

The processing of measuring an accurate sheet conveyance distance in order to correct the sheet length result executed in steps S103, S107, and S203 of FIG. 10 is summarized in FIG. 11. When this processing starts, in step S301, the start trigger sensor 34 detects that the leading end of the conveyed paper sheet 28 has passed. At step S302, a pulse signal is generated at the rotary encoder 33. In step S303, counting of the number of pulses is started by the pulse counting unit 36.

In step S304, the stop trigger sensor 35 detects that the trailing end of the conveyed paper sheet 28 has passed. In step S305, the counting of the number of pulses is ended by the pulse counting unit 36.

In step S306, the conveyance distance calculating unit 37 acquires the detection result of the start trigger sensor 34, the detection result of the stop trigger sensor 35, and the count result of the pulse counting unit 36 from each of the start trigger sensor 34, the stop trigger sensor 35, and the pulse counting unit 36, calculates the sheet conveyance distance on the basis of each acquired result and the sheet information, and, the measurement processing of the sheet conveyance distance is ended.

As described above, the manner of winding the paper sheet 28 around the driven roller 32 changes depending on the physical characteristics of the paper sheet 28. As a result, there is a difference between the conveyance speed on the front face of the driven roller 32 and the conveyance speed of the paper sheet 28, and the conveyance distance per encoder pulse count also varies depending on the type of paper sheet 28. In the present method, a more accurate calculation of the conveyance distance is implemented by correcting the conveyance distance calculated by the rotary encoder 33 based on the physical characteristic information of the paper sheet 28. As a result, the difference between the true sheet length and the measured sheet length can be minimized.

In the related art that measures a sheet length to correct an image magnification error, the measurement result of the sheet length is corrected on the basis of only the thickness of the sheet and the shape of a contact member. As a result, a sheet conveyance distance that varies depending on the physical characteristics of the sheet is not corrected, and the difference between the true sheet length and the measured sheet length may be large depending on the sheet.

As described above, in the present method, a more accurate calculation of the conveyance distance is implemented by correcting the conveyance distance calculated based on the physical characteristic information of a sheet. As a result, the difference between the true sheet length and the measured sheet length can be minimized.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A sheet conveying device comprising:
a conveyor to convey a sheet;
a measuring device on the conveyor to measure a conveyance amount of the sheet;
a first sensor downstream from the conveyor in a sheet conveyance direction of the conveyor to detect the sheet; and
a second sensor upstream from the conveyor in the sheet conveyance direction of the conveyor to detect the sheet; and
circuitry configured to calculate a conveyance distance of the sheet on basis of a measurement result of the conveyance amount of the sheet measured by the measuring device, a first detection result of the sheet detected by the first sensor, a second detection result of the sheet detected by the second sensor, and information indicating physical characteristics of the sheet.

2. The sheet conveying device according to claim 1,
wherein the conveyor includes a driving roller and a driven roller to rotate with rotation of the driving roller while nipping the sheet together with the driving roller, and
the information indicating the physical characteristics of the sheet is a diameter correction value for correcting a diameter of the driven roller when the driven roller nips the sheet together with the driving roller.

3. The sheet conveying device according to claim 2,
wherein the information indicating the physical characteristics of the sheet includes the diameter correction value for each of the physical characteristics of the sheet.

4. The sheet conveying device according to claim 2,
wherein the measuring device includes:
a rotation detector that is mounted on a rotation shaft of the driven roller to detect rotation of the driven roller and output a rectangular-wave signal; and
a conveyance amount measurer that to measure the conveyance amount of the sheet on basis of the rectangular-wave signal output from the rotation detector.

5. The sheet conveying device according to claim 2,
wherein the circuitry is configured to:
calculate a conveyance distance of a known sheet on basis of a measurement result of the known sheet measured by the measuring device, the known sheet having a known true value of a sheet length that is a length in the sheet conveyance direction; a first detection result of the known sheet detected by the first sensor; a second detection result of the known sheet detected by the second sensor; and information indicating physical characteristics of the known sheet, and
calculate a diameter correction value for correcting the diameter of the driven roller when the driven roller nips the known sheet with the driving roller, as the information indicating the physical characteristics of the known sheet, on basis of a value of the sheet length obtained from the calculated conveyance distance and the known true value.

6. The sheet conveying device according to claim 5,
wherein the circuitry is configured to calculate a difference between the value of the sheet length obtained from the calculated conveyance distance and the known true value as a sheet length calculation error, and calculate the diameter correction value from a value of the diameter of the driven roller obtained when the sheet length calculation error is zero.

7. The sheet conveying device according to claim 2,
wherein the circuitry is configured to
calculate conveyance distances of two or more known sheets on basis of a measurement result of the two or more known sheets measured by the measuring device, the two or more known sheets having identical physical characteristics, different sheet lengths that are lengths in the sheet conveyance direction, and known true values of the different sheet lengths; a first detection result of the two or more known sheets detected by the first sensor; a second detection result of the two or more known sheets detected by the second sensor; and information indicating the physical characteristics of the two or more known sheets, and
calculate a diameter correction value for correcting the diameter of the driven roller when the driven roller nips the two or more known sheets with the driving roller, as the information indicating the physical characteristics of the two or more known sheets, on basis of values of the sheet lengths obtained from the calculated conveyance distances and the known true values.

8. The sheet conveying device according to claim 7,
wherein the circuitry is configured to:
calculate, for each of the two or more known sheets, a difference between a value of the sheet length obtained from the calculated conveyance distance and the known true value as a sheet length calculation error; and
calculate the diameter correction value from a value of the diameter of the driven roller obtained when the two or more known sheets are equal in the sheet length calculation error.

9. An image forming apparatus comprising:
an image forming device to form an image on a sheet; and
a sheet conveying device to convey the sheet to the image forming device, the sheet conveying device including:
a conveyor to convey the sheet;
a measuring device on the conveyor to measure a conveyance amount of the sheet;
a first sensor downstream from the conveyor in a sheet conveyance direction of the conveyor to detect the sheet; and
a second sensor upstream from the conveyor in the sheet conveyance direction of the conveyor to detect the sheet; and
circuitry configured to calculate a conveyance distance of the sheet on basis of a measurement result of the conveyance amount of the sheet measured by the measuring device, a first detection result of the sheet detected by the first sensor, a second detection result of the sheet detected by the second sensor, and information indicating physical characteristics of the sheet.

10. A method for measuring a conveyance distance of a sheet by a sheet conveying device that includes a conveyor to convey the sheet, a measuring device on the conveyor, a first sensor downstream from the conveyor in a sheet conveyance direction of the conveyor; and a second sensor upstream from the conveyor in the sheet conveyance direction, the method comprising:
detecting a leading end of the sheet in the sheet conveyance direction by the first sensor;
detecting a trailing end of the sheet in the sheet conveyance direction by the second sensor;
measuring a conveyance amount of the sheet by the measuring device; and
calculating a conveyance distance of the sheet on basis of a measurement result of the sheet measured by the measuring, a first detection result of the sheet by the detecting of the leading end, a second detection result of the sheet by the detecting of the trailing end, and information indicating physical characteristics of the sheet.

11. A non-transitory storage medium storing instruction code which, when executed by one or more processors, causes the one or more processors to execute the method according to claim 10 in the sheet conveying device.
